(19) United States
(12) Patent Application Publication
(10) Pub. No.: US 2012/0153581 A1
(43) Pub. Date: Jun. 21, 2012

(54) Integrated Air Springs System and Inflatable Air Dam Assembly

(75) Inventor: Yunjun Li, West Bloomfield, MI (US)

(73) Assignee: GM GLOBAL TECHNOLOGY OPERATIONS LLC, DETROIT, MI (US)

(21) Appl. No.: 12/969,680

(22) Filed: Dec. 16, 2010

(51) Int. Cl. B60G 17/016; B60G 17/015; B60G 17/052; B62D 37/02

(52) U.S. Cl. 280/5.514; 296/180.1; 280/6.157

(57) ABSTRACT

An integrated pneumatic system including a motor, air compressor, air dryer, valves, air lines and electronic controller pneumatically controls both an air springs system and an inflatable air dam assembly, wherein the trim height adjustment of the air springs may be individual or collective, and wherein the trim height adjustment of the air springs and the inflation and deflation of the inflatable air dam assembly may be mutually coordinated with respect to vehicular speed and the duration of vehicular speed ranges.

### TECHNICAL FIELD

The present invention relates generally to motor vehicle air springs systems and inflatable air dam assemblies, and more particularly to an inflatable air dam assembly which is selectively inflated and deflated by integrated operation of the air springs system.

### BACKGROUND OF THE INVENTION

Motor vehicle air springs systems utilize compressed air operated leveling devices, as for example air springs and/or air spring over shock absorber modules or a combination thereof, to provide ride and leveling control of the vehicle. Such air suspension systems utilize an air compressor to provide a source of compressed air to the air operated leveling devices. In a typical configuration, as for example described in any of U.S. Pat. Nos. 4,829,436, 5,465,209, 6,698,778, and 7,617,031 the air compressor is selectively connected by electronically controlled solenoid valves to the air operated leveling devices, a compressed air reservoir (optional), an air intake, and an air exhaust. Most air suspension systems operate in an “open state” in the sense the excess air volume within the system is vented to the atmosphere at the exhaust and the source air for the compressor is drawn from the atmosphere at the intake; however, at least one air suspension system (see above cited U.S. Pat. No. 6,698,778) operates in a “closed state” in the sense that air is not exchanged with the atmosphere, wherein excess air volume is stored in an air reservoir and the source air for the compressor is either the air reservoir or the air springs.

Turning attention now to FIG. 1, an example of a prior art motor vehicle suspension system 10 is depicted, as generally also shown and described in aforementioned U.S. Pat. No. 4,829,436 to Kowalik et al, issued on May 9, 1989, the disclosure of which is hereby incorporated herein by reference.

The motor vehicle air suspension system 10 includes four compressed air operated leveling devices 12 which may be air springs and/or air spring over shock absorber modules, or a combination thereof, a computer 14, a compressor/exhaust apparatus 16, an air drier 18, a pressure switch 20, a valve assembly 22, a plurality of air lines 24 and signal lines 26. The plurality of air lines 24 go to the four leveling devices 12 to provide pressurized air from the valve assembly 22. A road wheel 28 is associated with each leveling device 12. The computer 14 receives an ignition signal, vehicle speed signal and vehicle door disposition signal. The computer 14 controls the operation of each solenoid valve in the valve assembly 22. The computer 14 also receives input from four position sensors 32, one at each of the four road wheels 28 through the four signal lines 26, as well as other inputs 34, such as ignition, doors, speed, etc. The compressor/exhaust apparatus 16 selectively sources or vents air through the air drier 18. A master air line 30 runs from the pressure switch 20 to the valve assembly 22 which controls compressed air communication between the compressor/exhaust apparatus 16 and the individual leveling devices 12 in response to signals from the computer 14. The pressure switch 20 is optional, and is used to monitor the air pressure at each air leveling device 12.

Turning attention now to FIGS. 2 and 3, a selectively inflatable and deflatable air dam is depicted, as has been described in U.S. patent application Ser. No. 12/767,276 filed on Apr. 26, 2010, entitled “Inflatable Vehicle Air Dam with Bidirectional Deploy/Stow System” to Li, et al, the disclosure of which is hereby incorporated herein by reference.

Referring to FIG. 2, it is seen that a vehicle generally indicated at 40 has a molded plastic front fascia 42 that conceals a front bumper bar and other structure of the vehicle body, not shown. An air dam assembly 44 is attached to the underside of the vehicle 40 and is shown in FIG. 1 at an extended position in which the air dam assembly 44 will partially close out the space between the under side of the vehicle and the road surface in order to improve the aerodynamic characteristics of the vehicle. The particular inflatable air dam assembly 44 discussed herein is one example of an inflatable air dam that may be employed with the bidirectional deploy/stow system, as described in the above referenced patent application.

The air dam assembly 44 is comprised of a one-piece blow molded plastic assembly that includes generally a top wall 46, a bottom wall 48, a forward wall 50, and a rearward wall 52. These walls cooperate to define a hollow interior sealed air space 54, and the walls have thicknesses that prove the generally self supporting shape of FIG. 2, as opposed to being of a thinner material that would not be self supporting of the shape. The top wall 46 is generally planar and is suitably attached to the underside of a suitable vehicle body structure 56 by screws 58 and 60. A hollow stem 62 is molded integrally with the top wall 46 and extends upwardly through an aperture 64 provided in the structure 56. This stem 62 may include a quick connect/disconnect feature for ease of assembly/disassembly if so desired.

The forward wall 50 and the rearward wall 52 are each formed of a plurality of serially arranged horizontal extending pleats 66. A typical pleat 66 includes an upper pleat portion 68 and a lower pleat portion 70 that are joined together by an outer living hinge 72. Each of these pleats 66 is in turn connected to the adjacent pleat 66 by inner living hinges 74. Thus the forward wall 50 and the rearward wall 52 consist of alternating pleat portions 68 and 70 that are connected by living hinges 72 and 74 that are arranged in accordion fashion by which the forward and rearward walls can be folded and unfolded via flexure of the living hinges. These living hinges and pleats are formed in the blow-molding process of forming the air dam assembly 44.

The bottom wall 48 of the air dam assembly spaces apart the forward wall 50 and the rearward wall 52. A front lower lip structure 76 depends downwardly from the forward wall 50 and the bottom wall 48 to stiffen the lower edge of the air dam assembly 44.

The overall shape of the air dam assembly 44 is curved or arcuate when seen from above so that the air dam assembly will generally match the curvature of the front of the vehicle. More importantly, this curved shape of the air dam assembly 44 causes the pleats 66 to also follow the curved path and in so doing the curvature of the pleats 68 and 70 and living hinges 72 and 74 will cooperate to generally stiffen the forward wall 50 and the rearward wall 52 against movement that might be induced by the on rushing air stream as the vehicle is traveling at predefined speeds. Furthermore, the pleated shape of the forward wall 50 and rearward wall 52 will cooperate to maintain a reliable distance between the forward and rearward walls, thereby giving the air dam assembly 44 a predetermined shape against flexure in the fore and aft direction.

Referring now to FIG. 3, the air dam assembly 44 is shown in a withdrawn position in which the bottom wall 48 has been retracted upwardly into closer proximity with the top wall 46 as permitted by the flexure of the living hinges 72 and 74 and the folding up of the pleat portions 68 and 70. Thus, in FIG. 3 the air dam assembly 44 has been deflatingly withdrawn to a stored position which is substantially away from possible interference with curbs or similar obstructions.

It will be understood that the air dam assembly 44 can be blow molded in either the extended position of FIG. 2 or the withdrawn position of FIG. 3. For example, if the air dam assembly 44 is molded in the extended position of FIG. 2, then the living hinges 72 and 74 will constantly urge the air dam assembly 44 to its extended position and the air dam assembly 14 can only be retracted by exerting sufficient deflation force on the air dam assembly 44 to overcome the natural and inherent spring effect of the living hinges. On the other hand, if the air dam assembly 44 is molded in the withdrawn position of FIG. 3, then the living hinges 72 and 74 will inherently urge the air dam assembly 44 to the withdrawn position and it will be necessary to exert sufficient inflation force to extend the air dam assembly 44 to its extended position of FIG. 2. Alternatively, the air dam assembly 44 can be molded in a condition that is midway between the extended (inflated) position and the withdrawn or retracted (deflated) position.

A bidirectional deploy/stow system is utilized for moving the air dam assembly 44 between the extended (inflated) position of FIG. 2 and the withdrawn or retracted (deflated) position of FIG. 3. This system includes an air compressor that may be driven by a motor (or by another means). The motor may be controlled by a controller, which may be a separate controller or may be part of a controller that is used to control other vehicle functions. This controller may be made up of various combinations of hardware and software as is known to those skilled in the art.

Problematically, the addition of a separate compressor/motor, valves, air dryer, controller, etc, of the deploy/stow system for the inflatable air dam assembly 44 is not only costly, but contributes to increased vehicular weight and occupation of otherwise available space for other vehicular components.

Accordingly, what is needed in the prior art is some way to operate the deploy/stow functions of the air dam assembly utilizing the air springs system of the motor vehicle.

### SUMMARY OF THE INVENTION

The present invention is an integrated pneumatic system for a motor vehicle in which inflatable air dam assembly inflation and deflation is operatively integrated with the air springs system of the motor vehicle, wherein the integration of shared components minimizes duplicity, thereby lowering vehicular weight and cost, while yet providing full functionality of all pneumatic systems of the motor vehicle.

The integrated pneumatic system according to the present invention includes a motor, air compressor, air dryer, valves (or valving), air lines and electronic controller, and provides pneumatic control over an inflatable air dam assembly and an air springs system, wherein the vehicle trim height adjustment of the air springs may be individual or collective, and wherein the vehicle trim height adjustment of the air springs and the inflation and deflation of the inflatable air dam assembly may be mutually coordinated with respect to vehicular speed and the duration of vehicular speed ranges so as to provide many advantages, including: optimized fuel mileage, improved vehicle ride quality minimized system mass and maximized system efficiency, as well as optimized vehicle road capability, head lamp leveling, etc.

Accordingly, it is an object of the present invention to provide an integrated pneumatic system for a motor vehicle in which inflatable air dam assembly inflation and deflation is operatively integrated with the air springs system of the motor vehicle, wherein the integration of shared components minimizes duplicity, thereby lowering vehicular weight and cost, while yet providing full functionality of all pneumatic systems of the motor vehicle.

### BRIEF DESCRIPTION OF THE DRAWINGS

FIG. 1 is a schematic diagram of a prior art motor vehicle air springs suspension system.

FIG. 2 is a schematic representation of an inflatable air dam assembly for a motor vehicle, shown at the extended, deployed or inflated configuration thereof.

FIG. 3 is a schematic representation of the inflatable air dam assembly for a motor vehicle of FIG. 2, now shown at the retracted, stowed or deflated configuration thereof.

FIG. 4 is a schematic representation of a first example of an integrated pneumatic system according to the present invention, shown holding vehicle trim height constant at the air springs of a two corner air suspension system and air pressure constant at the inflatable air dam.

FIG. 5 is a schematic representation of the first example of an integrated pneumatic system according to the present invention, shown raising the trim height of the air springs of the two corner air suspension system and holding air pressure constant at the inflatable air dam.

FIG. 6 is a schematic representation of the first example of an integrated pneumatic system according to the present invention, shown lowering the trim height of the air springs of the two corner air suspension system and holding air pressure constant at the inflatable air dam.

FIG. 7 is a schematic representation of the first example of an integrated pneumatic system according to the present invention, shown holding the trim height of the air springs of the two corner air suspension system and inflating the inflatable air dam.

FIG. 8 is a schematic representation of the first example of an integrated pneumatic system according to the present invention, shown holding the trim height of the air springs of the two corner air suspension system and deflating the inflatable air dam.

FIG. 9 is a schematic representation of a second example of an integrated pneumatic system according to the present invention, shown holding vehicle trim height constant at the air springs of a rear load leveling system and air pressure constant at the inflatable air dam.

FIG. 10 is a schematic representation of a second example of an integrated pneumatic system according to the present invention, shown holding vehicle trim height constant at the air springs of a four corner air suspension system and air pressure constant at the inflatable air dam.

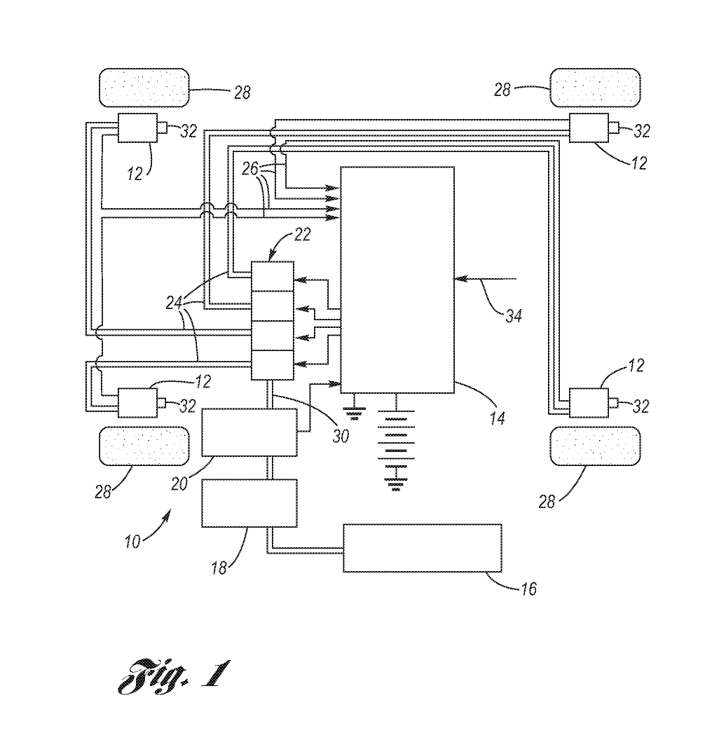

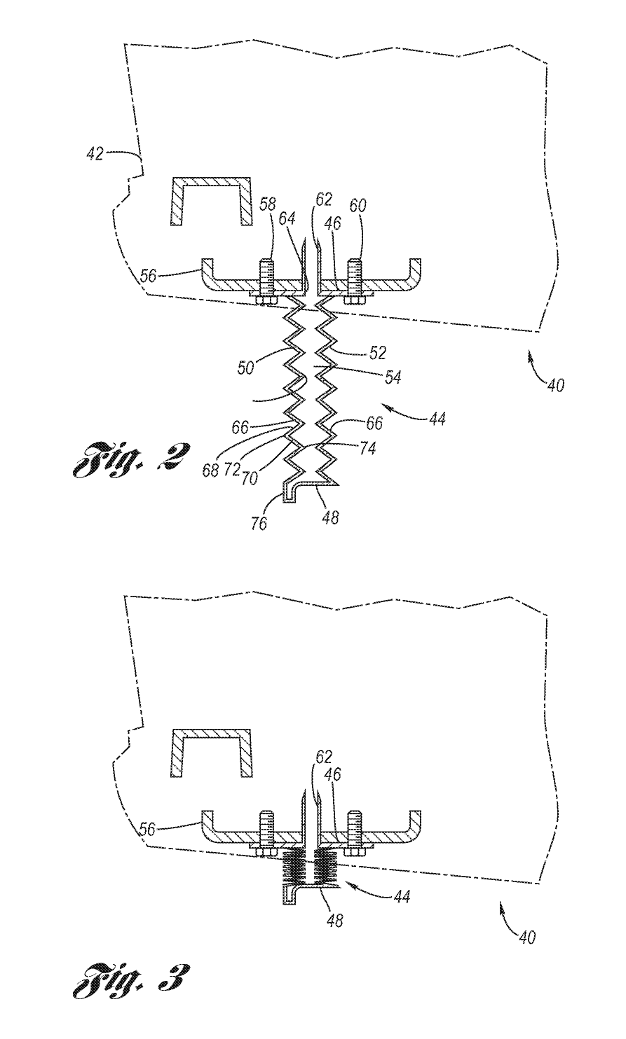

### DESCRIPTION OF THE PREFERRED EMBODIMENT

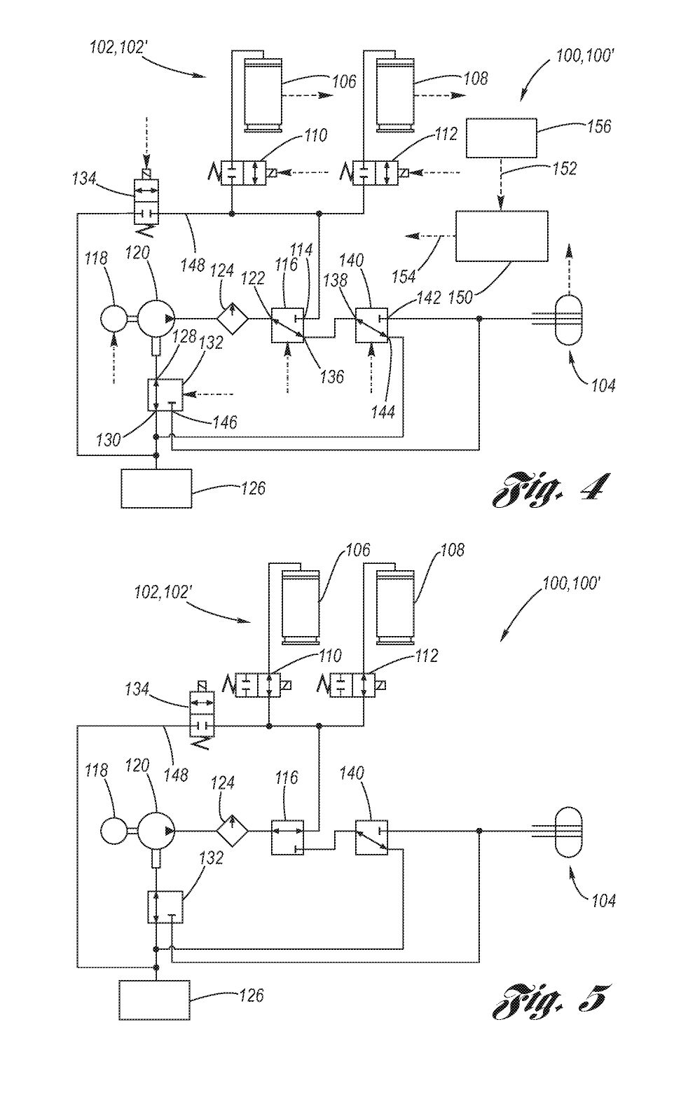

Referring now to FIGS. 4 through 10, depicted are various aspects of an integrated pneumatic system for a motor vehicle according to the present invention. In this regard, the integrated pneumatic system 100 includes a motor, air compressor, air dryer, valves (or valving), air lines and electronic controller, and provides pneumatic control over an air springs system 102 and an inflatable air dam assembly 104, wherein the trim height adjustment of the air springs and the inflation and deflation of the inflatable air dam assembly may be mutually coordinated with respect to vehicular speed and the duration of vehicular speed ranges so as to provide a number of advantages, including: optimized fuel mileage as well as optimized vehicle road capability and vehicle ride quality.

Turning attention now to FIGS. 4 through 8, a first example of an integrated pneumatic system 100, 100′ is depicted, wherein the air springs system 102 is a two-corner air springs suspension 102′.

As shown at FIG. 4, the air springs system 102, 102′, includes a pair of air springs 106, 108. The integrated pneumatic system 100, 100′ includes a motor 118, an air compressor 120, an air dryer 124, valves (or valving) 110, 112, 134, 116, 132, 140, pneumatic (or air) lines 148 and an electronic controller 150, and provides pneumatic control over an inflatable air dam assembly 104 and the air springs system 102, 102′.

Each air spring 106, 108 is connected to a respective solenoid valve 110, 112 which are pneumatically connected in parallel to a first output 114 of a first three-way pneumatic valve 116. The motor 118 actuates the air compressor 120 which supplies compressed air to the input 122 of the first three-way pneumatic valve 116, after having passed through the air dryer 124. The air compressor 120 draws air from the atmosphere 126 via the output 128 and first input 130 of a second three-way pneumatic valve 132. A second output 136 of the first three-way pneumatic valve 116 connects to the input 138 of a third three-way pneumatic valve 140, wherein a first output 142 of the third three-way pneumatic valve connects to the inflatable air dam assembly 104. A second output 144 of the third three-way pneumatic valve 140 connects to the atmosphere 126. A second input 146 of the second three-way pneumatic valve 132 connects to the inflatable air dam assembly 104. The aforesaid connections are pneumatic connections provided by the pneumatic lines 148. The electronic controller 150 receives sensor data from sensors 156 as an input via data line 152, and outputs appropriate signals via data lines 154, based upon its programming, to the motor 118, the three-way pneumatic valves 116, 132, 140 and the solenoid valves 110, 112, 134, via data lines 154.

At FIG. 4, the air springs 106, 108 and the inflatable air dam assembly 104 are held at fixed (or hold) positions based upon the indicated closed states of the solenoid valves 110, 112, 134, and the non-energized states of the first, second and third three-way pneumatic valves 116, 132, 140.

At FIG. 5, the air springs 106, 108 trim height is being raised and the inflatable air dam assembly 104 is being held at fixed air pressure. The electronic controller 150 has set solenoid valves 110 and 112 to their open state, set the solenoid valve 134 to its closed state, set the second and third three-way pneumatic valves 132, 140 to their non-energized state, and set the first three-way pneumatic valve 116 to its energized state, wherein the motor 118 is actuating the air compressor 120, draws air from the atmosphere through the second three-way pneumatic valve 132 and delivers compressed air through the first three-way pneumatic valve 116 and through the solenoid valves 110, 112 to the air springs 106, 108. In this regard, a selected one of the air springs trim height can be raised independent of the other by opening only the respective one of the solenoid valves 110, 112.

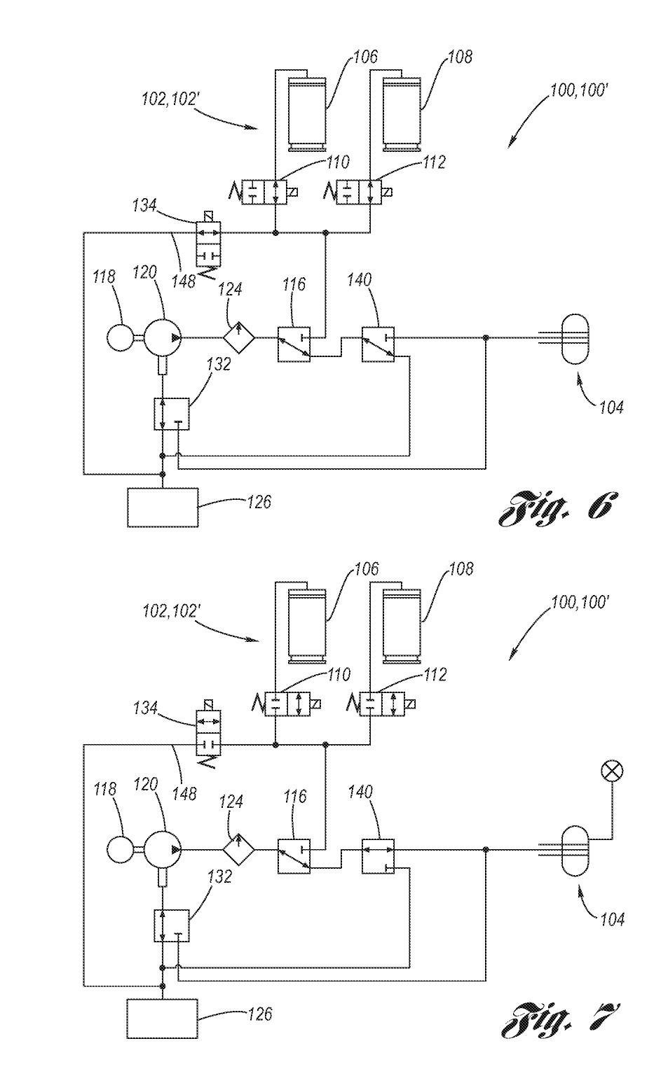

At FIG. 6, the air springs 106, 108 trim height is being lowered and the inflatable air dam assembly 104 is being held at fixed air pressure. The electronic controller 150 has set solenoid valves 110, 112 and 134 to their open state, set the first, second and third three-way pneumatic valves 116, 132, 140 to their non-energized state, wherein the motor 118 is not actuating the air compressor 120. Compressed air from the air springs 106, 108 flows through the solenoid valves 110, 112, 134 to atmosphere 126. In this regard, a selected one of the air springs trim height can be lowered independent of the other by opening only the respective one of the solenoid valves 110, 112.

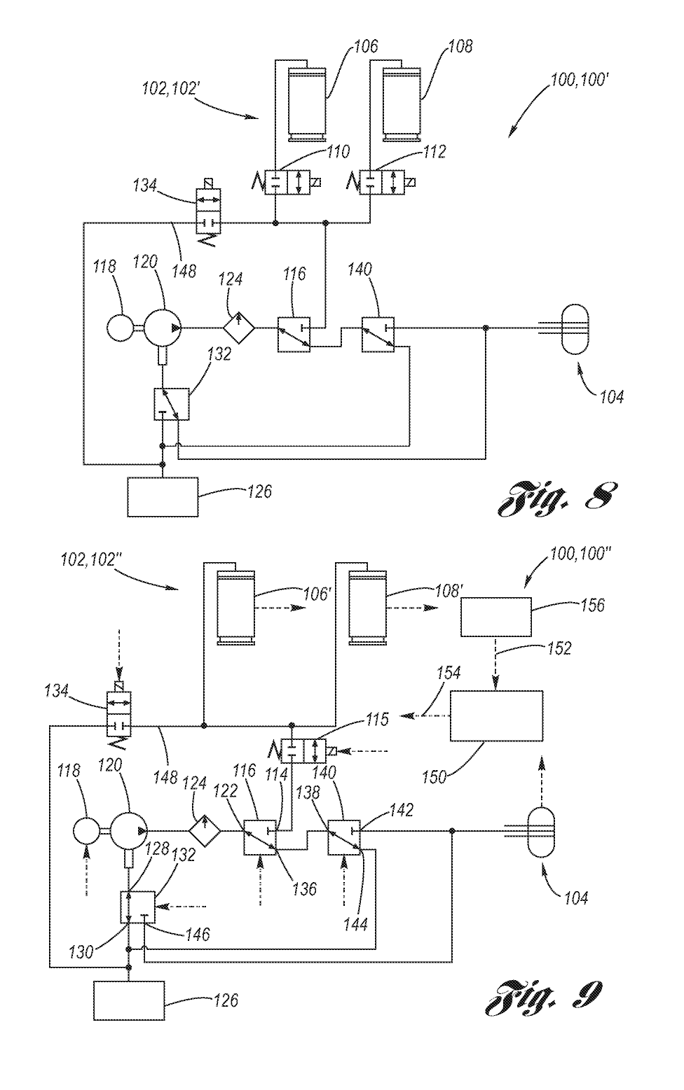

At FIG. 7, the air springs 106, 108 trim height is being held constant and the inflatable air dam assembly 104 is being inflated. The electronic controller 150 has set solenoid valves 110, 112 and 134 to their closed state, set the first and second three-way pneumatic valves 116, 132 to their non-energized state, and set the third three-way pneumatic valve 140 to its energized state, wherein the motor 118 is actuating the air compressor 120. Air is drawn from the atmosphere 126 through the second three-way pneumatic valve 132 and compressed air flows through the first three-way pneumatic valve 116 and through the third three-way pneumatic valve 140 to the inflatable air dam assembly 104.

At FIG. 8, the air springs 106, 108 trim height is being held constant and the inflatable air dam assembly 104 is being deflated. The electronic controller 150 has set solenoid valves 110, 112 and 134 to their closed state, set the first and third three-way pneumatic valves 116, 140 to their non-energized state, and set the second three-way pneumatic valve 132 to its energized state, wherein the motor 118 is actuating the air compressor 120. Air is drawn from the inflatable air dam assembly 104 via the second three-way pneumatic valve 132, and compressed air flows through the first three-way pneumatic valve 116 and through the third three-way pneumatic valve 140 to the atmosphere 126.

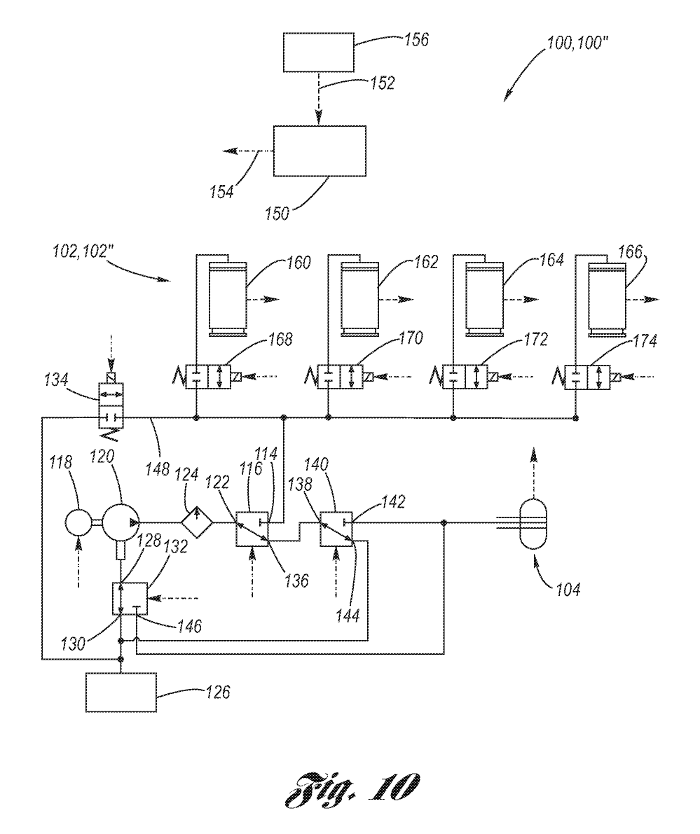

Turning attention now to FIG. 9, a second example of an integrated pneumatic system 100, 100″ is depicted, wherein the air springs system 102 is a rear load leveling system 102″, wherein like components to that of FIG. 4 have like reference numerals. It will be seen that the essential change from the configuration of FIG. 4 is that the solenoid valves 110 and 112 have been replaced by a single solenoid valve 115 connecting to the first output 114 of the first three-way pneumatic valve 116 and connecting in parallel to the air springs 106′, 108′. Operation is as generally described hereinabove with respect to FIGS. 4 through 8, wherein now the open and closed state of the solenoid valve 115 controls the trim height air springs in unison.

Turning attention now to FIG. 10, a third example of an integrated pneumatic system 100, 100′″ is depicted, wherein the air springs system 102 is a four corner air springs suspension system 102′″, wherein like components to that of FIG. 4 have like reference numerals. It will be seen that the essential change from the configuration of FIG. 4 is that there is now four air springs 160, 162, 164, 166, each with its respective solenoid valve 168, 170, 172, 174. Operation is as generally described hereinabove with respect to FIGS. 4 through 8, wherein now the open and closed state of each of the solenoid valves controls the trim height of its respective air spring.

From the foregoing disclosure, it will be evident that the following aspects pertain to the integrated pneumatic system according to the present invention. The system is preferably an open system, and jointly utilizes the motor, air compressor, air dryer, valves, and controller for both the air springs system and the inflatable air dam assembly.

Inflation and deflation of the inflatable air dam assembly and the raising and lowering of vehicle trim height provided by the air springs system, for example an air suspension system or a load leveling system, may be coordinated synergistically to cooperatively benefit operation of the motor vehicle. For example, for predetermined vehicle speeds for predetermined durations, the inflatable air dam assembly may be either inflated, deflated or held in the deflated or inflated configuration, and the air springs may raise, lower or hold steady the trim height (or height) of the vehicle, wherein the synergistic coordination is predetermined so as to optimize vehicle fuel economy, ride quality, vehicle appearance, road clearance, vehicle leveling, etc.

For example, when the vehicle speed is above a pre-defined speed threshold V₁ for a duration T₁, then the air compressor will be turned on and the valves set to inflate the inflatable air dam assembly; when the vehicle speed is below a pre-defined speed threshold V₂ for a duration T₂, then the air compressor will be turned on and the valves set to deflate the inflatable air dam assembly; when the vehicle speed is above a pre-defined speed threshold V₃ for a duration T₃, then the valves will be set to allow air to exhaust to atmosphere from (any one or all) of the air springs in order to lower the vehicle trim height; and when the vehicle speed is below a pre-defined speed threshold V₄ for a duration T₄, then the air compressor will be turned on and the valves set to deliver compressed air to (any one or all) of the air springs in order to raise the vehicle trim height, wherein the values of V₁, V₂, V₃, V₄, T₁, T₂, T₃ and T₄ are predetermined, as for example by modeling or empirical testing, for applicability to a certain vehicle and monitoring of road and vehicle operation conditions. Examples, merely for illustration and not limitation, of the aforesaid values may be as follows: V₁=25 MPH (miles/hour), V₂=20 MPH, V₃=50 MPH, V₄=45 MPH, T₁=20 seconds, T₂=20 seconds, T₃=between 30 and 45 seconds, and T₄=between 30 and 45 seconds.

Sensors for implementing the control logic of the controller may include: pressure sensors at various locations, preferably including over charge monitoring of the inflatable air dam assembly; trim height sensors; and inflatable air dam assembly configuration confirmation sensors. In this regard further, the integrated pneumatic system according to the present invention may further include an electronically controlled damping system for implementing a predetermined damping strategy; and system failure monitoring and failure mode diagnosis.

Each of the systems can be serviced separately. To service the air spring suspension system (air springs 106, 108, solenoid valves 110, 112), it is preferred to exhaust all the air from air spring first, as per FIG. 6. The air spring suspension system is then raised to a desired vehicle trim height after servicing, as per FIG. 5. To service the inflatable air dam assembly 104 and the second and third three-way pneumatic valves 132, 140, the air dam should be at its stow (or hold) position, as per FIG. 4. The systems should be in placed into hold position to service the air compressor 120, the motor 118, the dryer 124, and the first three-way pneumatic valve 116.

The dryer 124 can be regenerated during deflation of the air dam because air pressure and flow rate are relatively lower than that of the air springs. Another way to regenerate the air dryer 124, is to add a check valve (one end is between motor 120 and the dryer, and the other end between the motor 120 and the second three-way valve 132). To do this, set solenoid valves 110 or 112 to the open state, set the first three-way pneumatic valve 116 to the energized state, let air from air springs go through valves 110 or 112, 116, and 124, then the check valve, and then valve 132 to atmosphere 126. The check valve should be small orifice to limit the air flow rate.

To those skilled in the art to which this invention appertains, the above described preferred embodiment may be subject to change or modification. Such change or modification can be carried out without departing from the scope of the invention, which is intended to be limited only by the scope of the appended claims.

1. An integrated air springs system and inflatable air dam assembly of a motor vehicle, comprising:
an air springs system comprising a plurality of air springs;
an inflatable air dam assembly; and
an integrated pneumatic system connected with said air springs system and with said inflatable air dam assembly, said integrated pneumatic system selectively changing trim height of said plurality of air springs and selectively inflating and deflating said inflatable air dam assembly.

2. The integrated air springs system and inflatable air dam assembly of claim 1, wherein said integrated pneumatic system comprises:
an air compressor;
a motor actuating said air compressor; and
a plurality of valves connected with atmosphere, with said air compressor, with said air springs system and with said inflatable air dam, said plurality of valves selectively providing:
draw air for said air compressor from atmosphere;
draw air of said air compressor from said inflatable air dam assembly;
venting of compressed air from at least any one air spring of said plurality of air springs to atmosphere;
delivery of compressed air to at least any one air spring of said plurality of air springs; and
delivery of compressed air to said inflatable air dam assembly.

3. The integrated air springs system and inflatable air dam assembly of claim 2, further comprising:
an electronic controller interfaced with said motor and said valves; and
a plurality of sensors interfaced with said electronic controller;
wherein responsive to data from said plurality of sensors, said electronic controller effects said selective changing of trim height of said plurality of air springs and selective inflation and deflation of said inflatable air dam assembly.

4. The integrated air springs system and inflatable air dam assembly of claim 3, wherein said electronic controller effects said selective changing of trim height of said plurality of air springs and selective inflation and deflation said inflatable air dam assembly in a predetermined synergism of said air springs system and said inflatable air dam assembly with respect to predetermined operational characteristics of the motor vehicle.

5. The integrated air springs system and inflatable air dam assembly of claim 4, wherein said predetermined operational characteristics of the motor vehicle comprise selectively changing the trim height of said plurality of air springs and selectively inflating and deflating said inflatable air dam assembly by said electronic controller in response to sensed speed and speed duration of the motor vehicle.

6. The integrated air springs system and inflatable air dam assembly of claim 5, wherein said air spring system comprises at least one of a load leveling system and a multiple corner air springs suspension system.

7. The integrated air springs system and inflatable air dam assembly of claim 5, wherein said plurality of valves comprises:
a plurality of solenoid valves pneumatically connected to said plurality of air springs; and
a plurality of three-way pneumatic valves connected to atmosphere, to said plurality of solenoid valves, to said air compressor and to said inflatable air dam assembly.

8. The integrated air springs system and inflatable air dam assembly of claim 5, further comprising an air dryer disposed between said air compressor and said plurality of valves.

9. The integrated air springs system and inflatable air dam assembly of claim 6, wherein said plurality of valves comprises:
a plurality of solenoid valves pneumatically connected to said plurality of air springs; and
a plurality of three-way pneumatic valves connected to atmosphere, to said plurality of solenoid valves, to said air compressor and to said inflatable air dam assembly.

10. The integrated air springs system and inflatable air dam assembly of claim 9, further comprising an air dryer disposed between said air compressor and a three-way pneumatic valve of said plurality of three-way pneumatic valves.

11. An integrated air springs system and inflatable air dam assembly of a motor vehicle, comprising:
an air springs system comprising a plurality of air springs;
an inflatable air dam assembly; and
an integrated pneumatic system connected with said air springs system and with said inflatable air dam assembly, said integrated pneumatic system selectively changing trim height of said plurality of air springs and selectively inflating and deflating said inflatable air dam assembly, said integrated pneumatic system comprising:
an air compressor;
a motor actuating said air compressor; and
a plurality of valves connected with atmosphere, with said air compressor, with said air springs system and with said inflatable air dam.

12. The integrated air springs system and inflatable air dam assembly of claim 11, wherein said plurality of valves comprise:
valving which selectively provides draw air for said air compressor from atmosphere;
valving which selectively provides draw air of said air compressor from said inflatable air dam assembly;
valving which selectively provides venting of compressed air from at least any one air spring of said plurality of air springs to atmosphere;
valving which selectively provides delivery of compressed air to at least any one air spring of said plurality of air springs; and
valving which selectively provides delivery of compressed air to said inflatable air dam assembly.

13. The integrated air springs system and inflatable air dam assembly of claim 12, further comprising:
an electronic controller interfaced with said motor and said valves; and
a plurality of sensors interfaced with said electronic controller;
wherein responsive to data from said plurality of sensors, said electronic controller effects said selective changing of trim height of said plurality of air springs and selective inflation and deflation of said inflatable air dam assembly in a predetermined synergism of said air springs system and said inflatable air dam assembly responsive to sensed speed and speed duration of the motor vehicle

14. The integrated air springs system and inflatable air dam assembly of claim 13, wherein said air spring system comprises at least one of a load leveling system and a multiple corner air springs suspension system.

15. The integrated air springs system and inflatable air dam assembly of claim 14, wherein said plurality of valves comprises:
a plurality of solenoid valves pneumatically connected to said plurality of air springs; and
a plurality of three-way pneumatic valves connected to atmosphere, to said plurality of solenoid valves, to said air compressor and to said inflatable air dam assembly.

16. The integrated air springs system and inflatable air dam assembly of claim 15, further comprising an air dryer disposed between said air compressor and said plurality of valves.
